(19) United States
(12) Patent Application Publication
(10) Pub. No.: US 2009/0214199 A1
(43) Pub. Date: Aug. 27, 2009

(54) OPTICAL TRANSMISSION SYSTEM, NODE DEVICE, AND GMPLS CONTROL METHOD

(76) Inventor: Masayuki Fukai, Tokyo (JP)

Correspondence Address: NEC CORPORATION OF AMERICA, 6535 N. STATE HWY 161, IRVING, TX, 75039, US

(21) Appl. No.: 12/391,549

(22) Filed: Feb. 24, 2009

(30) Foreign Application Priority Data
Feb. 27, 2008 (JP) 2008-045361

(51) Int. Cl. H04B 10/02

(52) U.S. Cl. 398/7

(57) ABSTRACT

A node device according to the present invention includes an adjustment unit (GMPLS control unit) for, when an anomaly occurs on a route toward another node device, adjusting weighting of the route, and performs routing in Generalized Multi-Protocol Label Switching (GMPLS) control based on the adjusted weighting.

### INCORPORATION BY REFERENCE

This application is based upon and claims the benefit of priority from Japanese patent application No. 2008-045361, filed on Feb. 27, 2008; the disclosure of which is incorporated herein in its entirety by reference.

### BACKGROUND OF THE INVENTION

1. Field of the Invention

The present invention relates to an optical transmission system, a node device, and a GMPLS control method. More particularly, the present invention relates to routing in Generalized Multi-Protocol Label Switching (GMPLS) control.

2. Description of the Related Art

In recent years, GMPLS has gained attention as a new technology for supporting the next-generation ultra-fast backbone (see Japanese Patent Laid-Open Nos. 2006-352297, 2007-243567 and 2007-259315, for example). GMPLS is an extension to Multi-Protocol Label Switching (MPLS) which is utilized in an Internet Protocol-Virtual Private Network (IP-VPN) or the like for enabling it to be utilized in an optical network as well.

Since GMPLS uses a labeling technique to assign a label to a flow itself and perform switching based on information such labels and is capable of transmitting optical signals in units of wavelength, it allows switching at a high speed without converting optical signals. Furthermore, GMPLS has the advantages of high compatibility with conventional techniques and an ability to build a high-speed network with high scalability because it permits IP-level management and control.

To set paths in a distributed manner using a signaling protocol in GMPLS, a route is calculated based on topology information which is exchanged in GMPLS control plane via a routing protocol, such as Open Shortest Path First-Traffic Engineering (OSPF-TE).

Also in distributed path setting, a label is assigned to a path on a device at the time of end-to-end path setting by using signaling, such as of Resource reSerVation Protocol-Traffic Engineering (RSVP-TE), based on route information. The path label may be a timeslot of Synchronous Optical Network/Synchronous Digital Hierarchy (SONET/SDH), for example, or a wavelength of Wavelength Division Multiplexing (WDM).

An exemplary configuration of an optical transmission system that pertains to the present invention is described with reference to FIG. 10. In FIG. 10, WDM devices 3-1 and 3-4 convert data from client devices 4-1 and 4-2 to WDM wavelength (optical signals). The WDM devices 3-1 and 3-4 also conversely convert WDM wavelength and output data to the client devices 4-1 and 4-2. The client devices 4-1 and 4-2 output data to the WDM devices 3-1 and 3-4, or receive data from the WDM devices 3-1 and 3-4.

The respective GMPLS control units 31-1 to 31-5 of the WDM devices 3-1 to 3-5 perform GMPLS control. Fibers 301 to 305 connect the WDM devices 3-1 to 3-5 with each other.

The GMPLS control units 31-1 to 31-5 perform such route calculation as described above in GMPLS control and perform routing based on the result of route calculation. Here, the GMPLS control units 31-1 to 31-5 perform routing according to weighting of routes (weighting of priorities in route selection) that is set through manual operations in advance based on considerations such as cost.

For example, when a failure has occurred in a segment and route selection is required, a route that has the second highest priority after the route in the failed segment is selected according to the weighted priorities.

A problem associated with routing in the GMPLS that pertains to the present invention is that even an unstable route, such as one in which a failure has occurred, can be selected if it is given a high priority by weighting because fixed weighting is employed.

The patent documents listed above only describe that GMPLS is gaining attention and do not mention routing based on weighting, thus they cannot solve this problem.

### SUMMARY

An exemplary object of the present invention is to provide an optical transmission system, a node device, and a GMPLS control method that can select a stable route.

An optical transmission system according to an exemplary aspect of the present invention is an optical transmission system which includes a plurality of node devices, wherein

each of the plurality of node devices includes an adjustment unit for, when an anomaly occurs on a route toward another node device, adjusting weighting of the route, and

each of the plurality of node devices performs routing in Generalized Multi-Protocol Label Switching (GMPLS) control based on the adjusted weighting.

A node device according to an exemplary aspect of the present invention includes an adjustment unit for, when an anomaly occurs on a route toward another node device, adjusting weighting of the route, wherein

the node device performs routing in Generalized Multi-Protocol Label Switching (GMPLS) control based on the adjusted weighting.

A GMPLS control method according to an exemplary aspect of the present invention is a GMPLS control method for transmitting and receiving optical signals by Generalized Multi-Protocol Label Switching (GMPLS) in an optical transmission system that includes a plurality of node devices, the method including:

adjusting weighting of a route toward another node device in each of the plurality of node devices when an anomaly occurs on the route, wherein

each of the plurality of node devices performs routing in GMPLS control based on the adjusted weighting.

A recording medium according to an exemplary aspect of the present invention is a recording medium having recorded thereon a program to be executed by a computer in a node device which transmits and receives optical signals to and from another node device by Generalized Multi-Protocol Label Switching (GMPLS), the program including:

an adjustment process of, when an anomaly occurs on a route toward another node device, adjusting weighting of the route, wherein

the program causes the node device to perform routing in GMPLS control based on the adjusted weighting.

An optical transmission system according to an exemplary aspect of the present invention is an optical transmission system which includes a plurality of node devices, wherein

each of the plurality of node devices includes adjustment means for, when an anomaly occurs on a route toward another node device, adjusting weighting of the route, and

each of the plurality of node devices performs routing in Generalized Multi-Protocol Label Switching (GMPLS) control based on the adjusted weighting.

A node device according to an exemplary aspect of the present invention includes adjustment means for, when an anomaly occurs on a route toward another node device, adjusting weighting of the route, wherein
the node device performs routing in Generalized Multi-Protocol Label Switching (GMPLS) control based on the adjusted weighting.

### BRIEF DESCRIPTION OF THE DRAWINGS

FIG. 1 is a block diagram showing a configuration of a WDM device according to the present invention;

FIG. 2 is a block diagram showing a configuration of the WDM device according to a first exemplary embodiment of the invention;

FIG. 3 is a block diagram showing a configuration of an optical transmission system according to the first exemplary embodiment of the invention;

FIG. 4 is a block diagram showing a configuration of an optical transmission system according to a second exemplary embodiment of the invention;

FIG. 5 is a sequence chart illustrating operations of the optical transmission system according to the second exemplary embodiment of the invention;

FIG. 6 is a block diagram showing a configuration of an optical transmission system according to a third exemplary embodiment of the invention;

FIG. 7 is a sequence chart illustrating operations of the optical transmission system according to the third exemplary embodiment of the invention;

FIG. 8 illustrates operations of an optical transmission system according to a fourth exemplary embodiment of the invention;

FIG. 9 illustrates operations of an optical transmission system according to a fifth exemplary embodiment of the invention; and

FIG. 10 is a block diagram showing a configuration of an optical transmission system that pertains to the present invention.

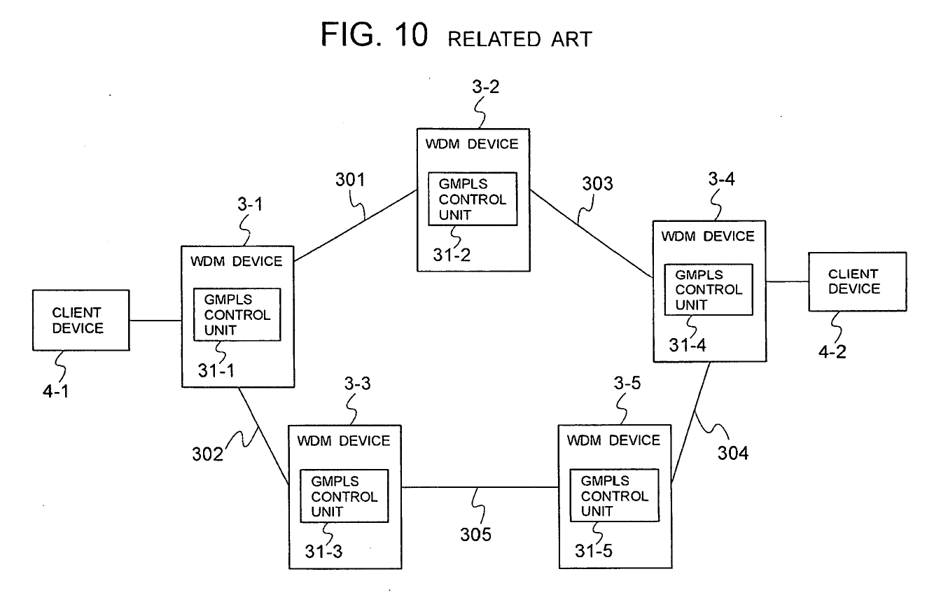

### EXEMPLARY EMBODIMENT

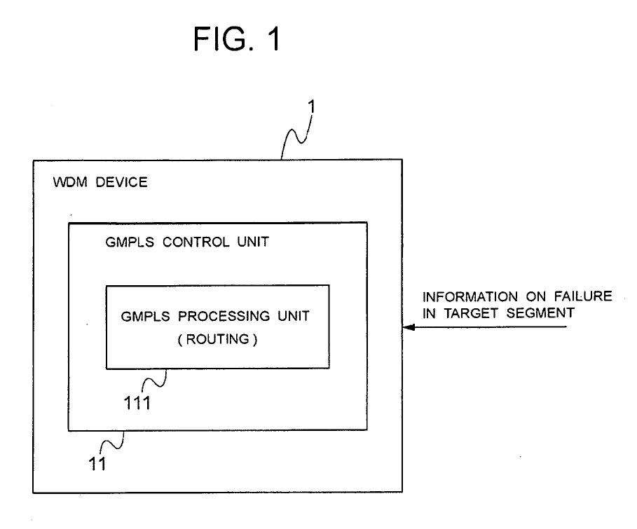

Now, exemplary embodiments of the present invention will be described with reference to drawings. First, the concept of the present invention is described with reference to FIG. 1. FIG. 1 shows an exemplary configuration of a Wavelength Division Multiplexing (WDM) device (or a node device) according to the present invention.

In FIG. 1, a WDM device 1 includes a GMPLS control unit 11 for performing GMPLS (Generalized Multi-Protocol Label Switching) control. The GMPLS control unit 11 includes a GMPLS processing unit 111 that performs processing for GMPLS control (e.g., routing).

Under normal conditions, the GMPLS control unit 11 selects a route based on parameters of weighting of individual routes which is set when an optical transmission system is designed. In addition, when an anomaly has occurred in a target segment for routing, the GMPLS control unit 11 automatically adjusts weighting of routes based on failure information provided from node devices (neighboring WDM devices and the like) in the target segment. Here, a target segment refers to a segment that is covered by routing performed when signals are transmitted and received, for example.

Thus, when a failure has occurred in a target segment for routing, weighting of routes is automatically adjusted based on information on the failure. The present invention can therefore select a stable route.

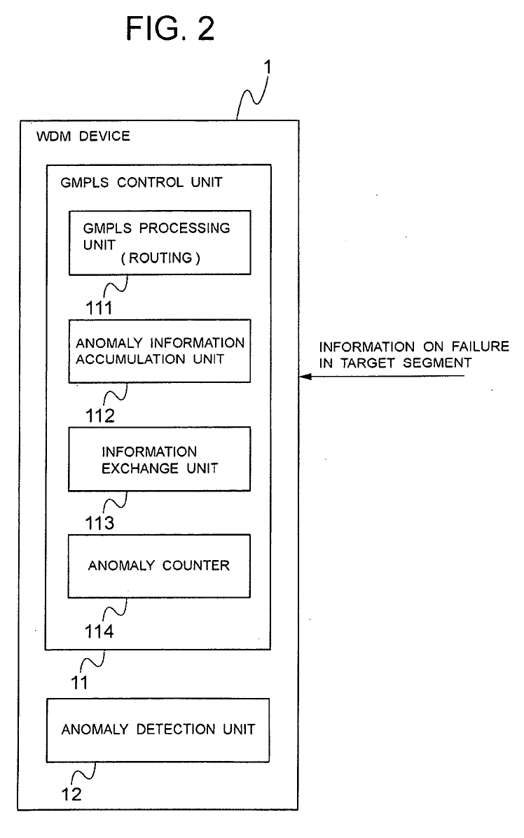

FIG. 2 is a block diagram showing a detailed configuration of the WDM device 1 according to the first exemplary embodiment of the invention. In FIG. 2, the WDM device 1 includes the GMPLS control unit 11 and an anomaly detection unit 12 for detecting an anomaly in a route or segment to which the WDM device 1 is connected.

The GMPSL control unit 11 includes the GMPLS processing unit 111 described above, an anomaly information accumulation unit 112, an information exchange unit 113, and an anomaly counter 114. The anomaly information accumulation unit 112 accumulates anomaly information, such as the number of anomaly detections on the device 1 and other devices. The information exchange unit 113 exchanges anomaly and other information with other WDM devices (not shown). The anomaly counter 114 counts the number of anomaly detections by the anomaly detection unit 12.

Types of anomaly that can be detected by the anomaly detection unit 12 include Loss Of Signal (LOS) in a WDM segment, device anomaly, wavelength anomaly, wavelength transfer anomaly and so forth. A WDM segment is a segment in which signals are wavelength-multiplexed. A wavelength anomaly is a bit error on a per-wavelength basis. A wavelength transfer anomaly is an anomaly that occurs when data is transferred from one wavelength to another wavelength.

Anomaly detection information is calculated from weights according to such anomaly types as shown above and the number of anomaly detections (or alarms). For example, assuming that a weight for an LOS is set to a score of 5, a bit error to 3, and a device anomaly to 7, when an LOS has occurred once, bit errors twice, and device anomalies three times, anomaly detection information is: 5×1+3×2+7×3=32.

As anomaly detection information described above is calculated on a per-route basis, the GMPLS processing unit 111 of the GMPLS control unit 11 performs routing based on such anomaly detection information of individual routes and other information on GMPLS that is generally used.

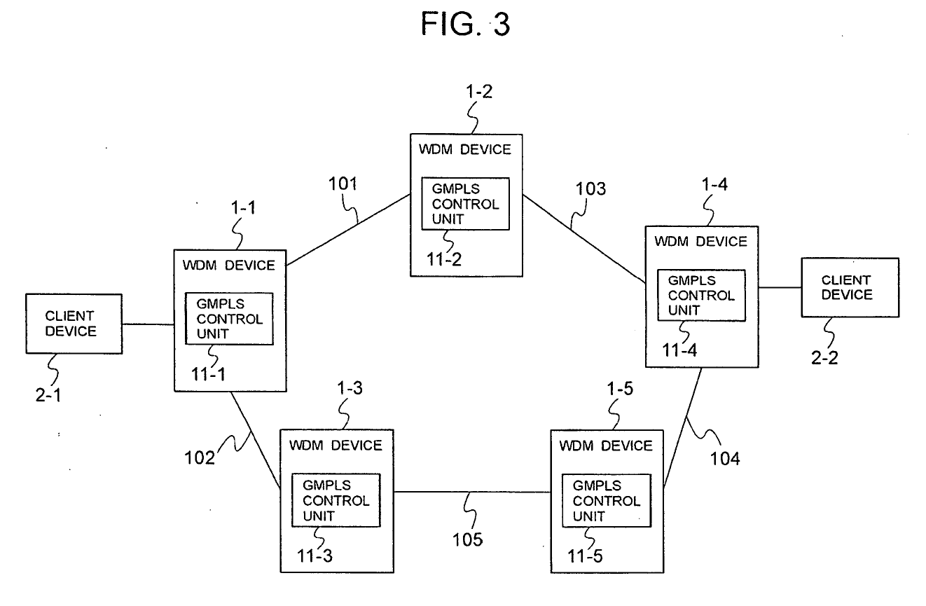

FIG. 3 is a block diagram showing a configuration of an optical transmission system according to the first exemplary embodiment of the invention. In FIG. 3, the optical transmission system according to the first exemplary embodiment of the invention includes the WDM devices 1-1 to 1-5 interconnected via fibers 101 to 105. In the first exemplary embodiment, client devices 2-1 and 2-2 are connected to the WDM devices 1-1 and 1-4, respectively.

The WDM devices 1-1 and 1-4 convert data from the client devices 2-1 and 2-2 to WDM wavelength. The WDM devices 1-1 and 1-4 also conversely convert WDM wavelength and output data to the client devices 2-1 and 2-2. The client devices 2-1 and 2-2 output data to the WDM devices 1-1 and 1-4 or receive data from the WDM devices 1-1 and 1-4.

The GMPLS control units 11-1 to 11-5 of the WDM devices 1-1 to 1-5 perform GMPLS control. The fibers 101 to 105 connect the WDM devices 1-1 to 1-5 with each other.

The GMPLS control units 11-1 to 11-5 perform route calculation as described above in GMPLS control and conduct routing based on the result of route calculation. In this case, the GMPLS control units 11-1 to 11-5 select a route according to parameters of weighting of individual routes which is set when the optical transmission system is designed, just as the GMPLS control unit 11 described above. In addition, the GMPLS control units 11-1 to 11-5 automatically adjust weighting of routes when an anomaly has occurred in a target segment for routing.

As described above, in the first exemplary embodiment, when a failure has occurred in the target segment for routing, information on the failure is accumulated in the GMPLS control units 11-1 to 11-5 and weighting of routes is automatically adjusted in accordance with the information. Therefore, the first exemplary embodiment can select a stable route.

More specifically, in the first exemplary embodiment, any of the fibers 101 to 105 is cut and one of the GMPSL control units 11-1 to 11-5 of the WDM devices 1-1 to 1-5 that has detected the anomaly disseminates information on the failure to the GMPSL control units of the other WDM devices. In the first exemplary embodiment, therefore, the number of times anomalies have occurred can be maintained as information and a route on which many of the anomalies have occurred can be avoided.

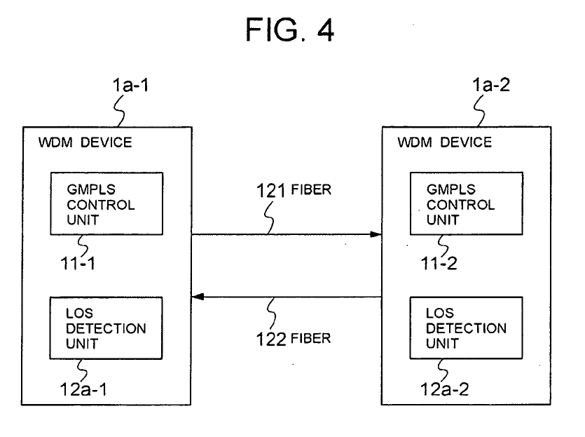

FIG. 4 is a block diagram showing a configuration of an optical transmission system according to a second exemplary embodiment of the present invention. In the optical transmission system according to the second exemplary embodiment of the invention shown in FIG. 4, LOS detection units 12a-1 and 12a-2 are implemented in the WDM devices 1a-1 and 1a-2, respectively, in place of the anomaly detection unit. 12. The WDM devices 1a-1 and 1a-2 otherwise have a similar configuration to that of the WDM device 1 shown in FIG. 2, and the same components are given the same reference numerals. The GMPLS control units 11-1 and 11-2 have a similar configuration to that of the GMPLS control unit 11 shown in FIG. 2.

The WDM device 1a-1 includes the GMPLS control unit 11-1 and the LOS detection unit 12a-1, outputs signals to the WDM device 1a-2 via the fiber 121, and receives signals from the WDM device 1a-2 via the fiber 122.

The WDM device 1a-2 includes the GMPLS control unit 11-2 and the LOS detection unit 12a-2, outputs signals to the WDM device 1a-1 via the fiber 122, and receives signals from the WDM device 1a-1 via the fiber 121.

The GMPLS control unit 11-1 performs processing required for GMPLS and exchanges information with the GMPLS control unit 11-2 of the WDM device 1a-2. The GMPLS control unit 11-2 performs processing required for GMPLS and exchanges information with the GMPLS control unit 11-1 of the WDM device 1a-1.

The LOS detection unit 12a-1 detects an LOS on the fiber 122 and provides the GMPSL control unit 11-1 with information on the LOS detected. The LOS detection unit 12a-2 detects an LOS on the fiber 121 and provides the GMPSL control unit 11-2 with information on the LOS detected.

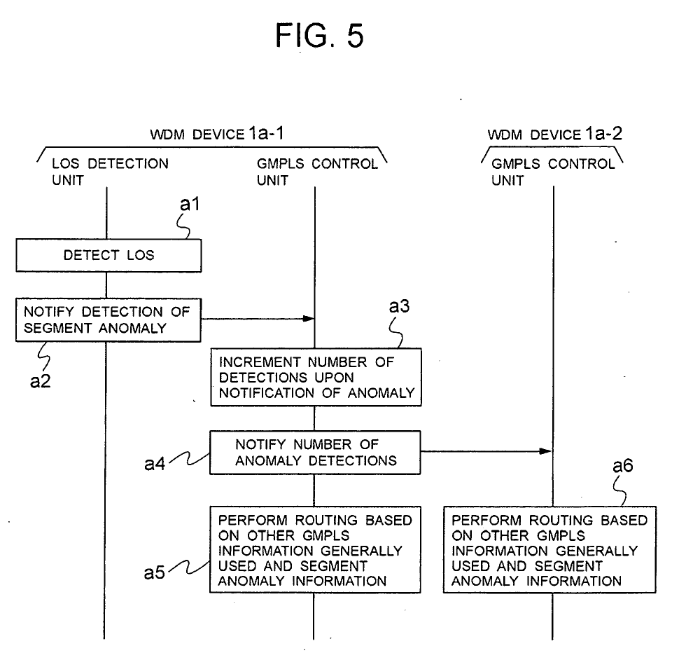

FIG. 5 is a sequence chart illustrating operations of the optical transmission system according to the second exemplary embodiment of the present invention. With reference to FIGS. 4 and 5, operations of the optical transmission system according to the second exemplary embodiment of the invention will be described. Processing operations of the WDM devices 1a-1 and 1a-2 in FIG. 5 can be realized by the GMPLS control units 11-1 and 11-2 (which may be CPUs, for example) executing a program (a computer-executable program).

The following description illustrates a case where the fiber 122 is cut. In such a situation, the LOS detection unit 12a-1 of the WDM device 1a-1 detects an LOS as signal input via the fiber 122 stops (al in FIG. 5). The LOS detection unit 12a-1 notifies the GMPLS control unit 11-1 that an anomaly in the segment has been detected (a2 in FIG. 5).

The GMPLS control unit 11-1 increments the number of detections when it is informed of an anomaly by the LOS detection unit 12a-1 (s3 in FIG. 5). The GMPLS control units 11-1 notifies the GMPLS control unit 11-2 of the WDM device 1a-2 of the number of anomaly detections via the fiber 121 (a4 in FIG. 5).

The GMPLS control units 11-1 and 11-2 of the WDM devices 1a-1 and 1a-2 perform routing based on the segment anomaly information described herein and other information on GMPLS that is generally used (a5 and a6 in FIG. 5).

Thus, in the second exemplary embodiment, weighting of routes is automatically adjusted based on information on LOSs detected by the LOS detection units 12a-1 and 12a-2 of the WDM devices 1a-1 and 1a-2. The second exemplary embodiment therefore can select a stable route.

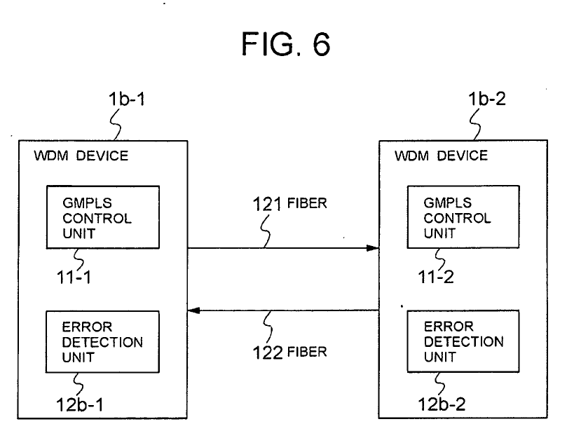

FIG. 6 is a block diagram showing a configuration of an optical transmission system according to a third exemplary embodiment of the present invention. In FIG. 6, the basic configuration of the optical transmission system according to the third exemplary embodiment of the present invention is similar to that of the optical transmission system according to the second exemplary embodiment shown in FIG. 4, but the third exemplary embodiment adds further device for anomaly detection.

Specifically, in the optical transmission system according to the third exemplary embodiment of the invention, error detection units 12b-1 and 12b-2 are implemented in WDM devices 1b-1 and 1b-2, respectively, in place of the LOS detection units 12a-1 and 12a-2. The WDM devices 1b-1 and 1b-2 otherwise have a similar configuration to that of the WDM devices 1a-1 and 1a-2 shown in FIG. 4, and the same components are given the same reference numerals. The GMPLS control units 11-1 and 11-2 have a similar configuration to that of the GMPLS control unit 11 shown in FIG. 2.

The WDM device 1b-1 includes the GMPLS control unit 11-1 and the error detection unit 12b-1, outputs signals to the WDM device 1b-2 via the fiber 121, and receives signals from the WDM device 1b-2 via the fiber 122.

The WDM device 1b-2 includes the GMPLS control unit 11-2 and the error detection unit 12b-2, outputs signals to the WDM device 1b-i via the fiber 122, and receives signals from the WDM device 1b-1 via the fiber 121.

The GMPLS control unit 11-1 performs processing required for GMPSL and exchanges information with the GMPLS control unit 11-2 of the WDM device 1b-2. The error detection unit 12b-1 monitors the number of signal errors and provides the GMPLS control unit 11-1 with information on the number of detected errors.

The GMPLS control unit 11-2 performs processing required for GMPLS and exchanges information with the GMPLS control unit 11-1 of the WDM device 1b-1. The error detection unit 12b-2 monitors the number of signal errors and provides the GMPLS control unit 11-2 with information on the number of detected errors.

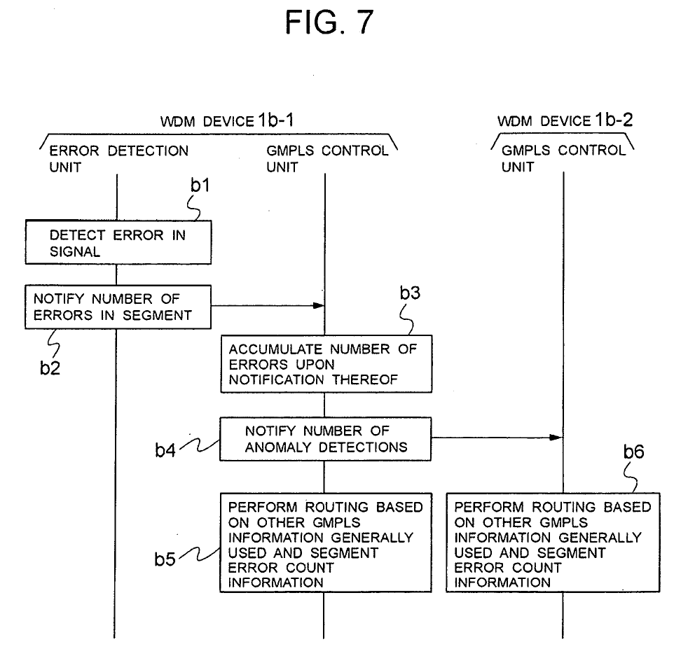

FIG. 7 is a sequence chart illustrating operations of the optical transmission system according to the third exemplary embodiment of the invention. With reference to FIGS. 6 and 7, operations of the optical transmission system according to the third exemplary embodiment of the invention are described. Processing operations of the WDM devices 1b-1 and 1b-2 in FIG. 7 can be realized by the GMPLS control units 11-1 and 11-2 (which may be CPUs, for example) executing a program (a computer-. executable program).

The following description illustrates a case where an error occurs on a route that passes through the fiber 122. Upon occurrence of the error, the error detection unit 12b-1 of the WDM device 1b-1 detects that there has been an error in a signal (b1 in FIG. 7). The error detection unit 12b-1 notifies the GMPLS control unit 11-1 of the number of errors in the segment (b2 in FIG. 7).

The GMPLS control unit 11-1 accumulates the number of errors upon notification of the number of errors from the error detection unit 12b-1 (b3 in FIG. 7). The GMPLS control unit 11-1 notifies the GMPLS control unit 11-2 of the WDM device 1b-2 of the number of detected anomalies via the fiber 121 (b4 in FIG. 7).

The GMPLS control units 11-1 and 11-2 of the WDM devices 1b-1 and 1b-2 perform routing based on the segment anomaly information (information on the number of errors) described herein and other information on GMPLS that is generally used (b5 and b6 in FIG. 7).

Thus, since the third exemplary embodiment uses signal error information instead of information on LOSs, it provides an advantage of the ability to select a more stable route even in a minor anomaly condition such as a signal error, not an anomaly to such an extent that input of light interrupts.

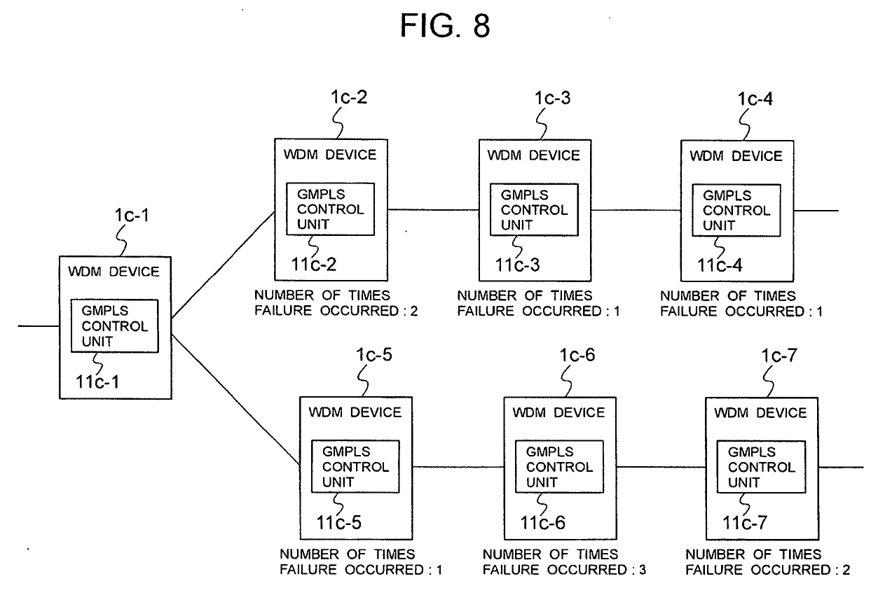

FIG. 8 illustrates operations of an optical transmission system according to a fourth exemplary embodiment of the present invention. In FIG. 8, the optical transmission system according to the fourth exemplary embodiment of the present invention has a basic configuration similar to that of any one of the first to third exemplary embodiments of the invention shown in FIGS. 2 to 7 described above or any combination thereof. In FIG. 8, WDM devices 1c -1 to 1c -7 include GMPLS control units 11c -1 to 11c -7, respectively.

The first to third exemplary embodiments of the invention described above all select a route based on failure information of neighboring node devices. Meanwhile, the fourth exemplary embodiment of the invention also collects failure information of node devices other than neighboring ones, that is, it collects failure information from neighboring node devices as well as other node devices, and performs routing, which is different from those exemplary embodiments.

In this case, failure information in the fourth exemplary embodiment can be collected using a known method that is an expansion of the method for receiving failure information from neighboring node devices described above. This known method may be a method in which a node device adds failure information detected on that node to failure information that has been so far received from the preceding node device and sends the failure information to the next node, for instance.

By way of example, when routing is performed on the WDM device 1c -1 as shown in FIG. 8, it is assumed that two failures have occurred on the WDM device 1c -2, one on the WDM device 1c -3, one on the WDM device 1c -4, one on the WDM device 1c -5, three on the WDM device 1c -6, and two on the WDM device 1c -7.

In this case, according to the first to third exemplary embodiments of the invention described above, the route on the side of the WDM device 1c -5 is selected from failure information on neighboring node devices, i.e., two failures occurred on the WDM device 1c -2 and one on WDM device 1c -5.

In the fourth exemplary embodiment, however, failure information of the WDM devices 1c -3 and 1c -4 is referenced for the route on the side of the WDM device 1c -2 and failure information of the WDM devices 1c -6 and 1c -7 is referenced for the route on the side of the WDM device 1c-5 at the time of routing. Accordingly, in the fourth exemplary embodiment, the route on the side of WDM device 1c -2 is selected.

While routing on the WDM device 1c -1 is performed based only on the number of failures, it is assumed that anomaly detection information is calculated based on the number of failures and the weights and the routing is performed based on the anomaly detection information, as in the first exemplary embodiment of the invention described above.

The fourth exemplary embodiment therefore provides similar effects to those provided by the first to third exemplary embodiment of the invention described above. Furthermore, the fourth exemplary embodiment provides an effect of enabling a more stable route to be selected based on failure information of neighboring node devices and other node devices that constitute routes.

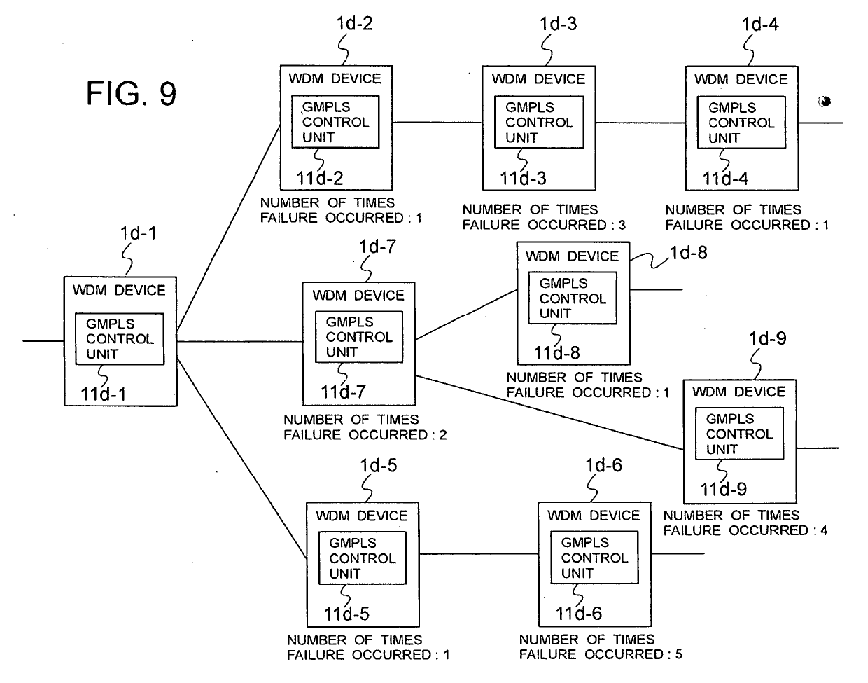

FIG. 9 illustrates operations of an optical transmission system according to a fifth exemplary embodiment of the present invention. In FIG. 9, the optical transmission system according to the fifth exemplary embodiment of the present invention has a basic configuration similar to that of any one of the first to fourth exemplary embodiments of the invention shown in FIGS. 2 to 8 described above or any combination thereof. In FIG. 9, WDM devices 1d-1 to 1d-9 include GMPLS control units 11d-1 to 11d-9, respectively.

All of the first to fourth exemplary embodiment of the invention described above select one of two routes when a node device is connected to two routes, whereas the fifth exemplary embodiment of the present invention selects one of three or more routes when a node device is connected to three or more routes, which is different from those exemplary embodiments.

For example, when routing is performed on the WDM device 1d-1, first, second, third, and fourth routes are connected to the WDM device 1d-1 as shown in FIG. 9. Here, the first route is a route that passes through WDM device 1d-2, then WDM device 1d-3, and WDM device 1d-4. The second route passes through WDM device 1d-5 and then WDM device 1d-6. The third route passes through WDM device 1d-7 and then WDM device 1d-8. The fourth route passes through WDM device 1d-7 and then WDM device 1d-9.

In the fifth exemplary embodiment, failure information is collected from neighboring node devices and other node devices and a route is selected based on the failure information as in the fourth exemplary embodiment of the invention described above. FIG. 9 shows that two failures have occurred on the WDM device 1d-2, three on the WDM device 1d-3, one on the WDM device 1d-4, one on the WDM device 1d-5, five on the WDM device 1d-6, two on the WDM device 1d-7, one on the WDM device 1d-8, and four on the WDM device 1d-9.

Therefore, in FIG. 9, a total of four failures have occurred on WDM devices 1d-2 and 1d-3 on the first route. On the second route, a total of six failures have occurred on the WDM devices 1d-5 and 1d-6. On the third route, a total of three failures have occurred on the WDM devices 1d-7 and 1d-8. On the fourth route, a total of six failures have occurred on the WDM devices 1d-7 and 1d-9. Accordingly, routing on the WDM device 1d-1 chooses the third route.

While routing on the WDM device 1d-1 is performed based only on the number of failures, it is assumed that anomaly detection information is calculated based on the number of failures and the weights and the routing is performed based on the anomaly detection information, as in the first exemplary embodiment of the invention described above.

The fifth exemplary embodiment therefore provides effects similar to those provided in the first to fourth exemplary embodiments of the invention described above. Furthermore, the fifth exemplary embodiment provides an effect of enabling a more stable route to be selected from among three or more routes based on failure information of individual node devices constituting routes. While in the fifth exemplary embodiment each route is made up of two or three node devices, the present invention is also applicable when a route is made up of four or more node devices.

An exemplary effect according to the present invention is the ability to select a stable route.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An optical transmission system which comprises a plurality of node devices, wherein
each of the plurality of node devices comprises an adjustment unit for, when an anomaly occurs on a route toward another node device, adjusting weighting of the route, and
each of the plurality of node devices performs routing in Generalized Multi-Protocol Label Switching (GMPLS) control based on the adjusted weighting.

2. The optical transmission system according to claim 1, wherein
each of the plurality of node devices includes a detection unit for detecting an anomaly on the route, and a notification unit for, when the anomaly is detected, notifying another node device of occurrence of the anomaly.

3. The optical transmission system according to claim 1, wherein
the adjustment unit adjusts the weighting when a loss of signal (LOS) occurs on a fiber that connects the plurality of node devices with each other.

4. The optical transmission system according to claim 1, wherein
the adjustment unit adjusts the weighting when an error occurs in a signal on the route.

5. The optical transmission system according to claim 1, wherein
the adjustment unit adjusts the weighting of the route based on failure information collected from neighboring node devices and failure information collected from node devices other than the neighboring node devices.

6. The optical transmission system according to claim 1, wherein
each of the plurality of node devices selects one of three or more routes in the routing.

7. A node device, comprising
an adjustment unit for, when an anomaly occurs on a route toward another node device, adjusting weighting of the route, wherein
the node device performs routing in Generalized Multi-Protocol Label Switching (GMPLS) control based on the adjusted weighting.

8. The node device according to claim 7, further comprising:
a detection unit for detecting an anomaly on the route, and a notification unit for, when the anomaly is detected, notifying another node device of occurrence of the anomaly.

9. The node device according to claim 7, wherein
the adjustment unit adjusts the weighting when a loss of signal (LOS) occurs on a fiber that connects the node device with another node device.

10. The node device according to claim 7, wherein
the adjustment unit adjusts the weighting when an error occurs in a signal on the route.

11. The node device according to claim 7, wherein
the adjustment unit adjusts the weighting of the route based on failure information collected from neighboring node devices and failure information collected from node devices other than the neighboring node devices.

12. The node device according to claim 7, wherein
the node device selects one of three or more routes in the routing.

13. A GMPLS control method for transmitting and receiving optical signals by Generalized Multi-Protocol Label Switching (GMPLS) in an optical transmission system that includes a plurality of node devices, the method comprising:
adjusting weighting of a route toward another node device in each of the plurality of node devices when an anomaly occurs on the route, wherein
each of the plurality of node devices performs routing in GMPLS control based on the adjusted weighting.

14. The GMPLS control method according to claim 13, further comprising:
detecting an anomaly on the route in each of the plurality of node devices, and notifying another node device of occurrence of the anomaly when the anomaly is detected.

15. The GMPLS control method according to claim 13, wherein
each of the plurality of node devices adjusts the weighting when a loss of signal (LOS) occurs on a fiber that connects the plurality of node devices with each other.

16. The GMPLS control method according to claim 13, wherein
each of the plurality of node devices adjusts the weighting when an error occurs in a signal on the route.

17. The GMPLS control method according to claim 13, wherein
each of the plurality of node devices adjusts the weighting of the route based on failure information collected from neighboring node devices and failure information collected from node devices other than the neighboring node devices.

18. The GMPLS control method according to claim 13, wherein
each of the plurality of node devices selects one of three or more routes in the routing.

19. A recording medium having recorded thereon a program to be executed by a computer in a node device which transmits and receives optical signals to and from another node device by Generalized Multi-Protocol Label Switching (GMPLS), the program comprising:
an adjustment process of, when an anomaly occurs on a route toward another node device, adjusting weighting of the route, wherein
the program causes the node device to perform routing in GMPLS control based on the adjusted weighting.

20. An optical transmission system which comprises a plurality of node devices, wherein
each of the plurality of node devices comprises adjustment means for, when an anomaly occurs on a route toward another node device, adjusting weighting of the route, and
each of the plurality of node devices performs routing in Generalized Multi-Protocol Label Switching (GMPLS) control based on the adjusted weighting.

21. A node device, comprising
adjustment means for, when an anomaly occurs on a route toward another node device, adjusting weighting of the route, wherein
the node device performs routing in Generalized Multi-Protocol Label Switching (GMPLS) control based on the adjusted weighting.
